(19) United States
(12) Patent Application Publication
(10) Pub. No.: US 2014/0028440 A1
(43) Pub. Date: Jan. 30, 2014

(54) APPARATUS AND METHOD FOR AUTOMOTIVE PROXIMITY DETECTION AND CONTROL

(71) Applicant: AISIN TECHNICAL CENTER OF AMERICA, INC., Plymouth, MI (US)

(72) Inventors: Katsuhiko TAKEUCHI, Canton, MI (US); Lindsey SZCZYGIEL, Plymouth, MI (US); Eric ARCHAMBEAU, Plymouth, MI (US); Kevin GARNER, Plymouth, MI (US)

(73) Assignee: AISIN TECHNICAL CENTER OF AMERICA, INC., Plymouth, MI (US)

(21) Appl. No.: 13/734,505

(22) Filed: Jan. 4, 2013

Related U.S. Application Data
(60) Provisional application No. 61/677,248, filed on Jul. 30, 2012.

(51) Int. Cl. G05B 1/01

(52) U.S. Cl. CPC G05B 1/01
USPC 340/5.61

(57) ABSTRACT

A method of proximity control for a vehicle comprises determining, by a proximity determination system, whether a user is located within a predetermined distance from the vehicle; and communicating, by a mobile device and/or internet-based device, with the vehicle to gain access to the vehicle based on the proximity determination result.

### BACKGROUND

1. Field of the Disclosure

Embodiments described herein relate generally to a system, method, computer program, and mobile device for vehicle proximity control.

2. Description of the Related Art

Modern mobile devices are capable of performing numerous functions in addition to transmitting and receiving voice data. In particular, mobile software applications may be installed on mobile devices to remotely control other systems using a wireless communication channel. For example, current mobile applications allow a user to control door locks, an ignition system, and/or a climate control system in a vehicle using an interface on a mobile device. Some mobile applications communicate via a separate key fob, which a vehicle owner carries for the purpose of remote communication with a vehicle.

FIG. 8 illustrates a prior art vehicle door controller from U.S. Publication Number 2009/0030579, and FIG. 9 illustrates a corresponding method of controlling the vehicle door controller of FIG. 8.

### SUMMARY

To ensure secure wireless communication between a mobile device and a vehicle it may be desirable to limit the allowable signal propagation distance over which a remote vehicle control mobile application sends a control signal. Therefore, a system is needed for determining whether a user is within a predetermined distance from a vehicle prior to permitting wireless proximity control with the vehicle control system.

A proximity control system of the present disclosure allows users a more simplified access to vehicle control functions based on a physical proximity determination. For example, a user can select a door to open on a vehicle at any distance from the vehicle; however, the door will not open until the user is detected within a predetermined distance from the vehicle. This will benefit the user because the proximity control system is a convenient hands-free system, which allows users who have their hands full to obtain easier access to their cars. Moreover, the user can predetermine the default door(s) to open prior to entering the specified or unspecified range of the proximity sensor. This allows for the user to utilize the proximity auto door system without having to manually select the door(s) upon arrival.

The proximity control system also provides the user a secure and convenient method to access the auto door system by limiting the propagation distance that a control signal travels when communicating wirelessly with a vehicle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram for an exemplary proximity control apparatus; and

FIG. 2 is an exemplary algorithmic flow chart of a vehicle proximity control system;

FIG. 3 is an algorithmic flow diagram of an exemplary method for vehicle proximity control by Bluetooth communication;

FIG. 4 is an algorithmic flow diagram of an exemplary method for vehicle proximity control by Wi-Fi communication;

FIG. 5 is an algorithmic flow diagram of an exemplary method for vehicle proximity control by radio-frequency identification (RFID) communication;

FIG. 6 is an algorithmic flow diagram of an exemplary method for vehicle proximity control by GPS;

FIG. 7 is a schematic diagram of a proximity control apparatus according to another exemplary embodiment;

FIG. 8 is a block diagram of a vehicle door controller; and

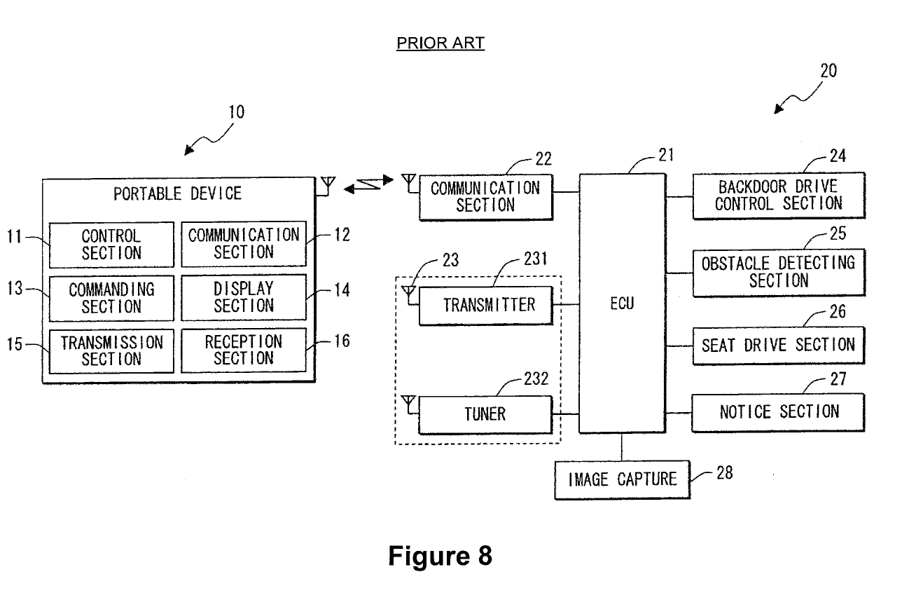

FIG. 9 is a method of controlling the vehicle door controller of FIG. 8.

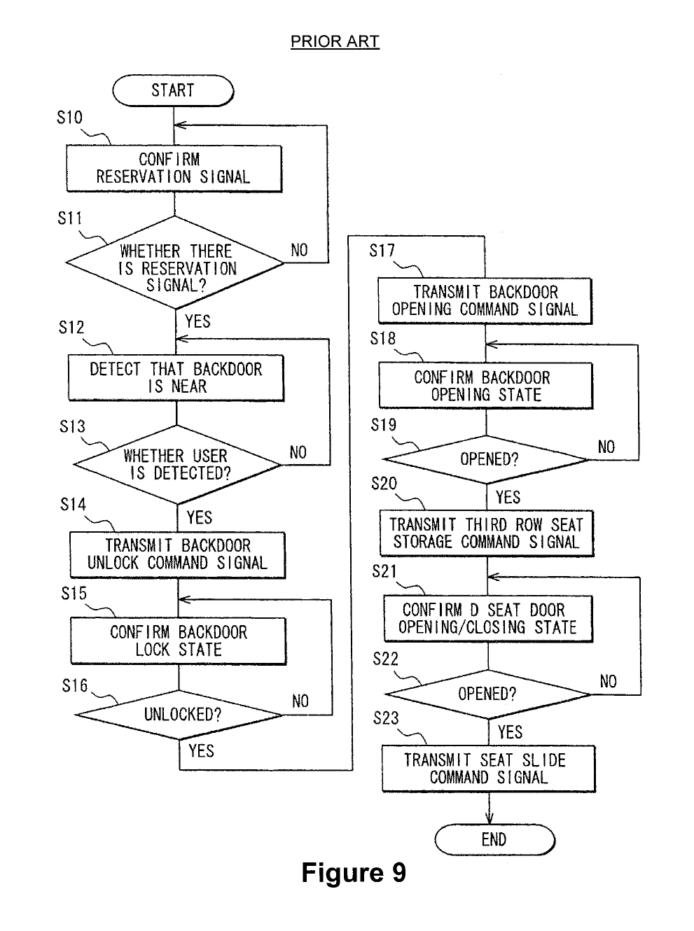

### DETAILED DESCRIPTION OF THE PREFERRED EMBODIMENTS

Referring now to the drawings, wherein like reference numerals designate identical or corresponding parts throughout the several views.

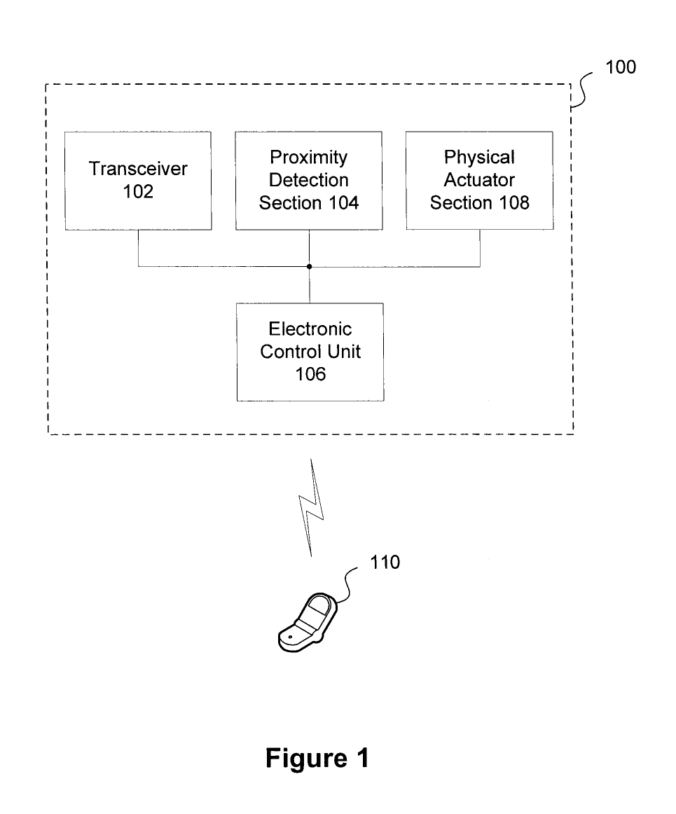

FIG. 1 illustrates an exemplary block diagram for vehicle proximity control device 100. The device includes a transceiver for communicating wirelessly with mobile device 110 via a predetermined communication channel. Proximity detection section 104 is configured to determine a distance from mobile device 110 to a corresponding vehicle using, e.g., a proximity sensor, an RFID transceiver, a GPS unit, a Bluetooth transceiver, and/or Wi-Fi. Electronic Control Unit (ECU) 106 receives an input if the distance determined by the proximity detection section 104 is within a predetermined distance. Based on the received input, ECU 106 outputs command signals to physical actuator section 108 to control a selected vehicle actuator. For example, ECU 106 may output a command signal to physical actuator section 108 for unlocking and opening a vehicle door.

Alternatively, vehicle proximity control device 100 may be configured such that the hardware (e.g., Bluetooth) limits communication between mobile device 110 and ECU 106 until the distance between vehicle proximity control device 100 and mobile device 110 is less than a predetermined threshold, thereby maintaining a secure connection.

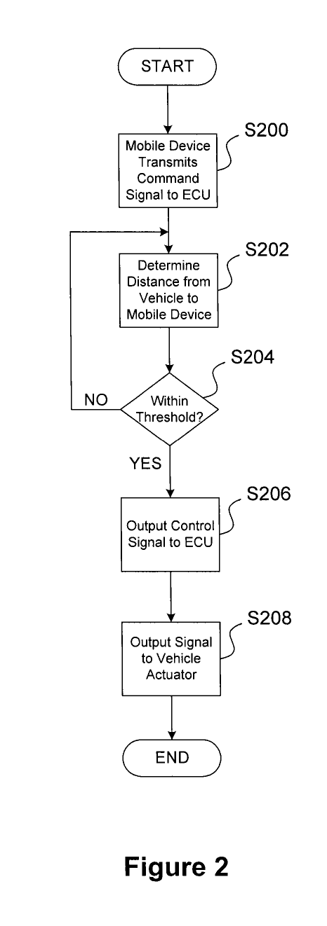

Next, FIG. 2 illustrates an exemplary algorithmic flow chart of a vehicle proximity control system. According to FIG. 2, a mobile device (e.g., a smartphone including a vehicle proximity control application) transmits a command signal to a vehicle ECU via a wireless communication channel (S200). For example, the mobile device may transmit a command signal for unlocking a specific vehicle door. A proximity determination system determines a distance from the vehicle to the mobile device at a time in which the command signal is received (S202). The mobile device hardware (e.g., Bluetooth) then determines whether the determined distance is within a predetermined distance threshold (S204). If the determined distance exceeds the threshold, the device continues determining its distance to the vehicle at a predetermined periodicity. Otherwise, if the threshold is not exceeded, the mobile device outputs a control signal to the ECU (S206). When the control signal is received, the ECU outputs a signal to the vehicle door lock actuator and the door is unlocked (S208).

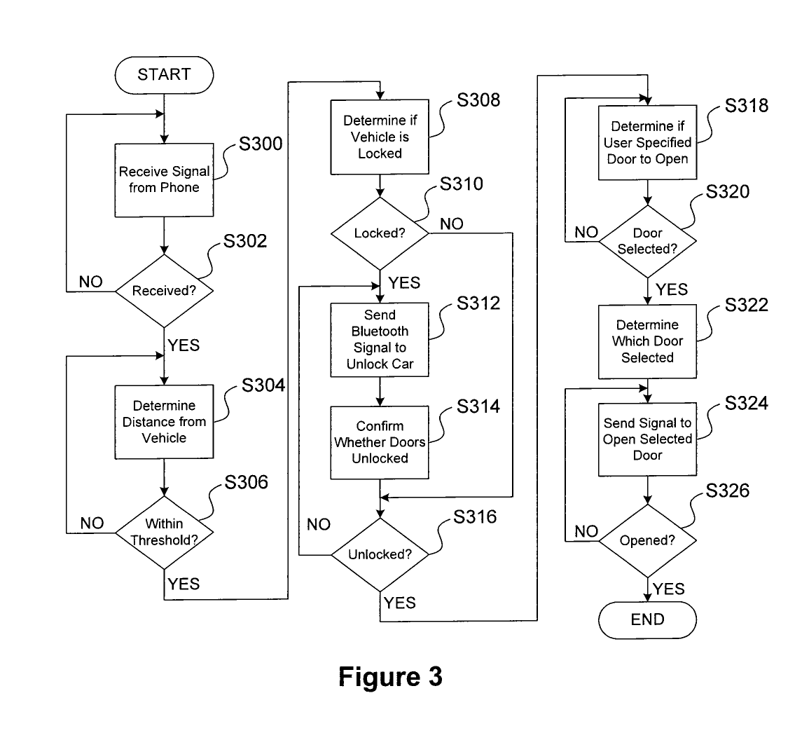

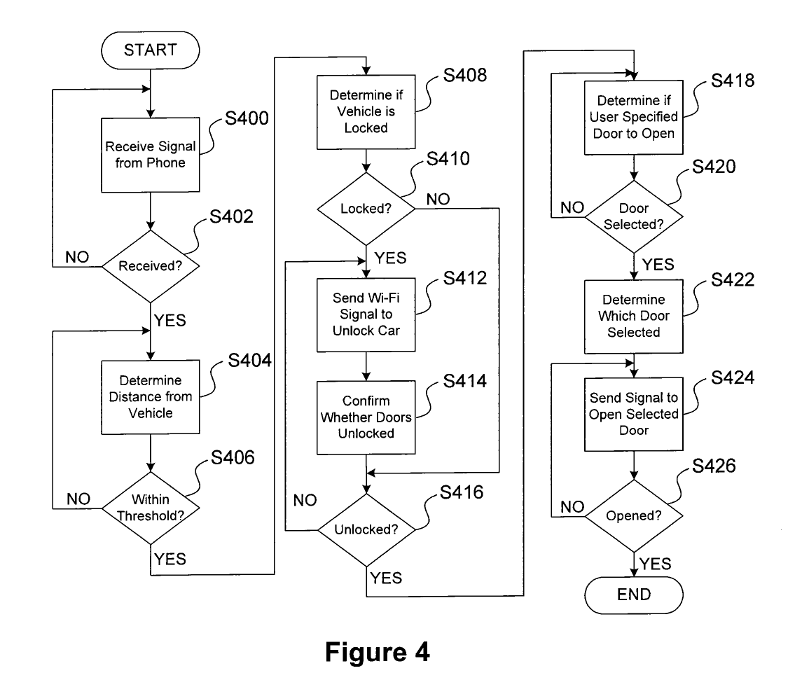

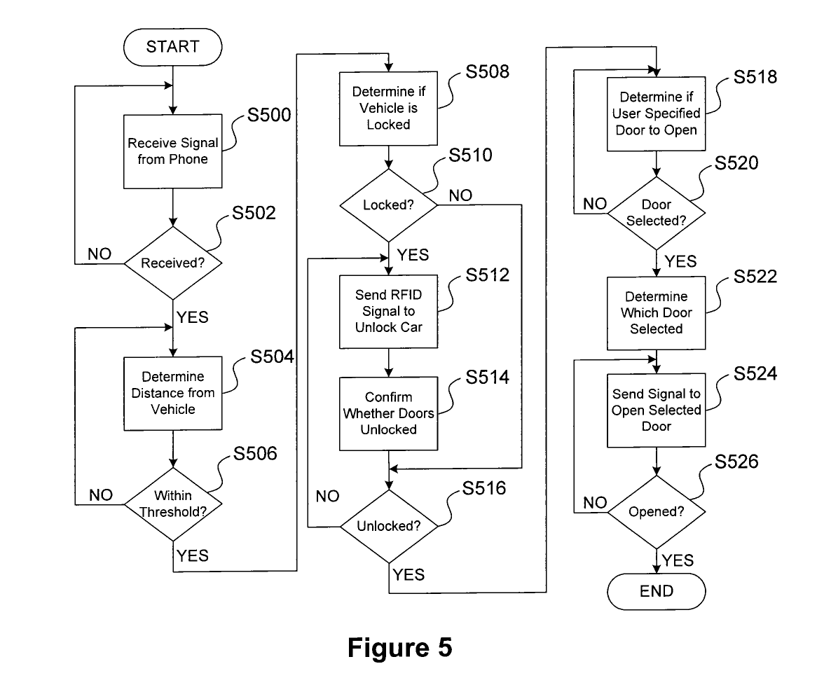

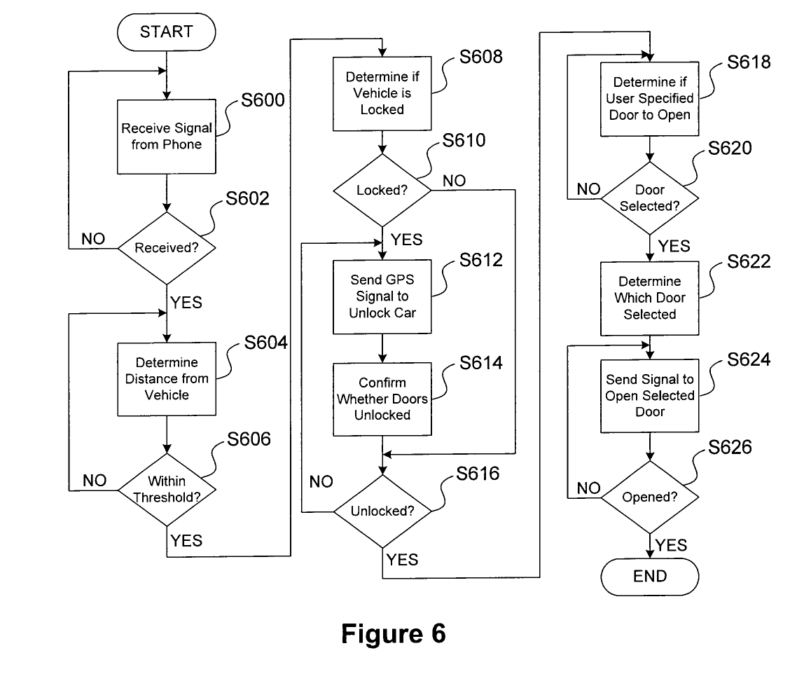

FIGS. 3-6 respectively illustrate an exemplary method for a vehicle proximity control system using Bluetooth, Wi-Fi, RFID, and GPS communication. It should be appreciated that each of the exemplary methods may be adapted according to the features of these communication channels. For simplicity, the discussion of the exemplary methods of FIGS. 3-6 is limited to Bluetooth, which is included in the process of FIG. 3. The processing steps of FIGS. 4-6 are similar to those of FIG. 3 with the exception of the communication protocol used (i.e., steps S412, S512, and S612).

Referring to FIG. 3, the system at step S300 awaits receipt of a signal from a mobile device (e.g., a smartphone). Once the signal is received (S302), a distance from the vehicle to the mobile device is determined at step S304 using the wireless communication channel (e.g., Bluetooth). When the mobile device is determined to be within a predetermined distance threshold at step S306 (e.g., five feet) of the vehicle, the system determines whether the vehicle doors are locked at step S308. The distance threshold setting may be adjusted or set as a default value (e.g. five feet). If the doors are locked (S310), a command signal is sent via the wireless communication channel (e.g., Bluetooth) to unlock the vehicle doors at step S312. Once the system verifies the vehicle doors are unlocked (S314 and S316), a determination is made at step S318 as to whether the user has selected a door to be opened at step S320 and if so, which door (S322). Otherwise, if at step 5316 the doors are determined to be locked, the system returns to step S312 and re-sends the Bluetooth signal. When the system determines that the user has selected a door to be opened at step S322, a second command signal is sent to the ECU at step S324 for opening the selected door. Lastly, the system verifies that the selected door was properly opened at step S326.

It should be appreciated that the present disclosure is not limited to unlocking and opening vehicle doors based upon a proximity determination. The exemplary embodiments may be further configured to operate other vehicle level controls, such as windows, a sunroof, engine ignition, interior/exterior lights, mirror positioning, sunshades, power tailgates, power running boards, air conditioning/heat, rear camera controls, and seat controls, based upon a similar proximity determination. For example, following a proximity determination such as those described in the above exemplary methods, an exemplary embodiment of the present disclosure may start a vehicle's ignition and begin warming the vehicle using the heating system prior to the driver entering the vehicle. Additionally, the present disclosure is not limited to opening driver and front/rear passenger doors, and can be further configured to provide proximity determination control of power sliding doors, power rear doors, pop out doors, and swing doors. A personal safety feature of including a 360-degree camera feed of an area surrounding a vehicle using proximity determination control is also in the purview of the present disclosure.

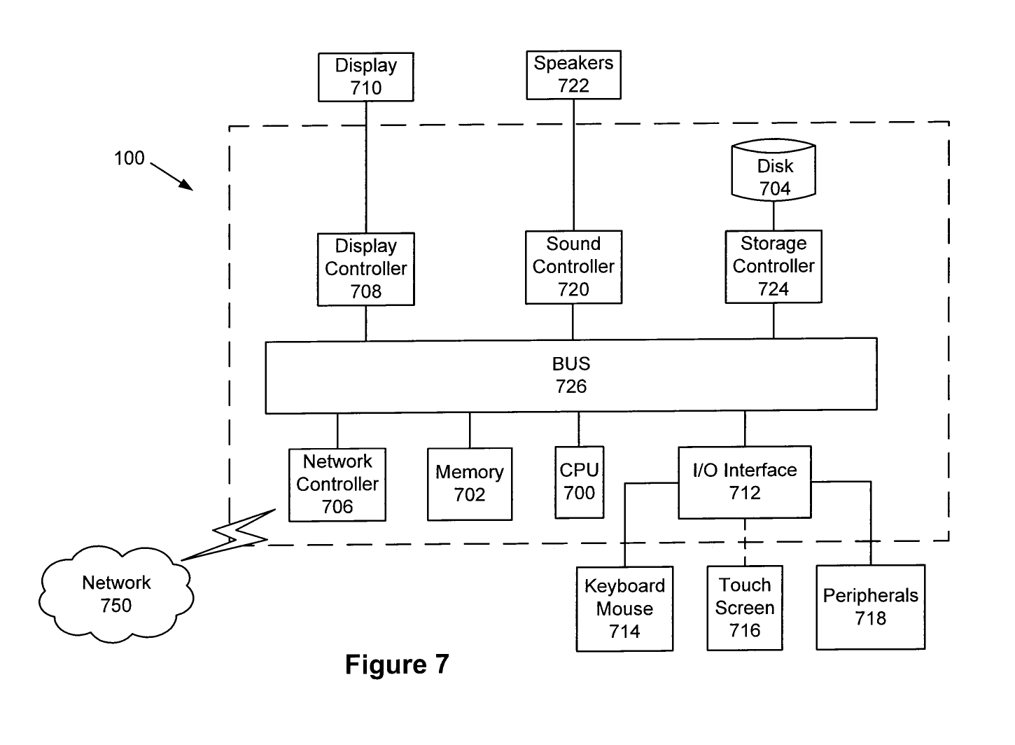

Next, a hardware description of vehicle proximity control device 100 according to exemplary embodiments is described with reference to FIG. 7. In FIG. 7, vehicle proximity control device 100 includes a CPU 700 which performs the processes described above. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer aided design station communicates, such as a server or computer.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The vehicle proximity control device 100 in FIG. 7 also includes a network controller 706, such as an Intel Ethernet PRO network interface card from Intel Corporation of America, for interfacing with network 750. As can be appreciated, the network 750 can be a public network, such as the Internet, or a private network such as a LAN or WAN network, or any combination thereof and can also include PSTN or ISDN sub-networks. The network 750 can also be wired, such as an Ethernet network, or can be wireless such as a cellular network including EDGE, 3G, and 4G wireless cellular systems. The wireless network can also be WiFi, Bluetooth, RFID, or any other wireless form of communication that is known.

The vehicle proximity control device 100 further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710.

A sound controller 720 is also provided in vehicle proximity control device 100, such as Sound Blaster X-Fi Titanium from Creative, to interface with speakers/microphone 722 thereby providing sounds and/or music. The speakers/microphone 722 can also be used to accept dictated words as commands for controlling vehicle proximity control device 100 or for providing location and/or property information with respect to the associated websites.

The general purpose storage controller 724 connects the storage medium disk 704 with communication bus 726, which may be an ISA, EISA, VESA, PCI, or similar, for interconnecting all of the components of vehicle proximity control device 100. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

Aspects of the present disclosure may also utilize a Controller Area Network (CAN) message-based network protocol to execute proximity determination control.

Obviously, numerous modifications and variations of the present disclosure are possible in light of the above teachings. It is therefore to be understood that within the scope of the appended claims, the present disclosure may be practiced otherwise than as specifically described herein.

The functions and features described herein may also be executed by various distributed components of a system. For example, one or more processors may execute these system functions, wherein the processors are distributed across multiple components communicating in a network. The distributed components may include one or more client and/or server machines, in addition to various human interface and/or communication devices (e.g., display monitors, smart phones, tablets, personal digital assistants (PDAs)). The network may be a private network, such as a LAN or WAN, or may be a public network, such as the Internet. Input to the system may be received via direct user input and/or received remotely either in real-time or as a batch process.

What is claimed:

1. A vehicle proximity control apparatus comprising:
a proximity detection section configured to determine whether a user is located within a predetermined distance from a vehicle to a mobile device by analyzing a signal received from the mobile device over a wireless communication channel; and
an electronic control unit configured to provide access to an interior of the vehicle based on the proximity determination result.

2. The vehicle proximity control apparatus of claim 1, further comprising:
a physical actuator section configured to control at least one of the vehicle's door lock actuators based on a control signal received from the electronic control unit, wherein
the electronic control unit provides access to the interior of the vehicle by generating the control signal based on the proximity determination result.

3. The vehicle proximity control apparatus of claim 2, wherein:
the proximity detection section determines whether the user is located within the predetermined distance when a request from the mobile device to gain access to the interior of the vehicle is received, and
the electronic control unit provides access to the interior of the vehicle when the user is determined to be within the predetermined distance.

4. The vehicle proximity control apparatus of claim 3, wherein when the request to gain access to the interior of the vehicle is received from the mobile device, if the proximity detection section determines the user is outside the predetermined distance from the vehicle, the proximity detection section continues performing the proximity determination until the user is determined to be within the predetermined distance.

5. The vehicle proximity control apparatus of claim 2, wherein the proximity detection section determines the distance to the mobile device via one or more of a proximity sensor, a radio-frequency identification (RFID) transceiver, a global positioning system (GPS) unit, a Bluetooth transceiver, and a Wi-Fi interface.

6. The vehicle proximity control apparatus of claim 2, wherein the physical actuator section is further configured to control, based on the proximity determination result, one or more of the vehicle's windows, heating and air conditioning, engine ignition, and seat functions.

7. A method of proximity control for a vehicle, the method comprising:
determining, by a proximity determination system, whether a user is located within a predetermined distance from the vehicle; and
communicating, by a mobile device and/or internet-based device, with an electronic control unit to gain access to an interior of the vehicle based on the proximity determination result.

8. The method of claim 7, further comprising:
operating and controlling, by a physical actuator section, at least one of the vehicle's door locks, based on the proximity determination, such that access is gained to the interior of the vehicle.

9. The method of claim 7, wherein the proximity determination and the communication to the vehicle is performed by one or more of a proximity sensor, an RFID transceiver, a GPS unit, a Bluetooth transceiver, and a Wi-Fi interface.

10. The method of claim 8, wherein the physical actuator section is further configured to control, based on the proximity determination result, one or more of the vehicle's windows, heating and air conditioning, engine ignition, and seat functions.

11. The method of claim 8, wherein:
the proximity detection section determines whether the user is located within the predetermined distance when a request from the mobile device to gain access to the interior of the vehicle is received, and
the electronic control unit provides access to the interior of the vehicle when the user is determined to be within the predetermined distance.

12. The method of claim 11, wherein following the request to gain access to the interior of the vehicle is received from the mobile device, if the proximity detection section determines the user is outside the predetermined distance from the vehicle, the proximity detection section continues performing the proximity determination until the user is determined to be within the predetermined distance.

13. A non-transitory computer readable medium having instructions stored therein that when executed by a processor causes a computer to perform a method of proximity detection control, the method comprising:
determining whether a user is located within a predetermined distance from the vehicle; and
communicating with the vehicle to gain access to an interior of the vehicle based on the proximity determination result.
